(19) United States
(12) Patent Application Publication
(10) Pub. No.: US 2026/0116012 A1
(43) Pub. Date: Apr. 30, 2026

(54) METHOD FOR MANUFACTURING THREE-DIMENSIONAL MOLDED OBJECT

(71) Applicant: SEIKO EPSON CORPORATION, TOKYO (JP)

(72) Inventor: Satoshi YAMAZAKI, MATSUMOTO-SHI (JP)

(21) Appl. No.: 19/004,223

(22) Filed: Dec. 28, 2024

(30) Foreign Application Priority Data
Dec. 28, 2023 (JP) 2023-222974

(51) Int. Cl. B29C 64/386; B33Y 50/00

(52) U.S. Cl. CPC B29C 64/386; B33Y 50/00

(57) ABSTRACT

Provided is a method for manufacturing a three-dimensional molded object by discharging a molding material from a discharge unit toward a stage to stack layers. The manufacturing method includes: a first step of displaying a three-dimensional molded object on a display unit based on shape data representing a three-dimensional shape of the three-dimensional molded object; a second step of determining a molding target region in the three-dimensional molded object displayed on the display unit based on a first region defining a range of a surface perpendicular to a stacking direction of the layer; a third step of generating first molding data based on data of a portion corresponding to the molding target region in the shape data, or generating third molding data by selecting the data of the portion corresponding to the molding target region from second molding data generated based on the shape data; and a fourth step of forming the three-dimensional molded object based on the first molding data or the third molding data.

The present application is based on, and claims priority from JP Application Serial Number 2023-222974, filed December 28, 2023, the disclosure of which is hereby incorporated by reference herein in its entirety.

### BACKGROUND

### 1. Technical Field

The present disclosure relates to a method for manufacturing a three-dimensional molded object.

### 2. Related Art

JP-A-2022-71244 discloses a method for manufacturing a three-dimensional molded object by discharging a molding material from a discharge unit toward a stage to stack layers.

When the three-dimensional molded object is subjected to test molding to confirm an actual molding state of a part of the three-dimensional molded object, such as an overhang portion or a support structure, since a portion other than a portion needed to be confirmed is also molde d, a molding time may be increased, or a use amount of the molding material may be increased. This problem is particularly noticeable when a three-dimensional molded object having a large size is subjected to the test molding.

### SUMMARY

According to a first aspect of the present disclosure, there is provided a method for manufacturing a three-dimensional molded object by discharging a molding material from a discharge unit toward a stage to stack layers. The manufacturing method includes: a first step of displaying a three-dimensional molded object on a display unit based on shape data representing a three-dimensional shape of the three-dimensional molded object; a second step of determining a molding target region in the three-dimensional molded object displayed on the display unit based on a first region defining a range of a surface perpendicular to a stacking direction of the layer; a third step of generating first molding data based on data of a portion corresponding to the molding target region in the shape data, or generating third molding data by selecting the data of the portion corresponding to the molding target region from second molding data generated based on the shape data; and a fourth step of forming the three-dimensional molded object based on the first molding data or the third molding data.

### BRIEF DESCRIPTION OF THE DRAWINGS

FIG. 1 is a diagram illustrating a schematic configuration of a three-dimensional molding system in a first embodiment.

FIG. 2 is a perspective view illustrating a schematic configuration of a flat screw.

FIG. 3 is a schematic plan view of a barrel.

FIG. 4 is a diagram schematically illustrating a state in which a three-dimensional molding device forms a molded object.

FIG. 5 is a diagram illustrating a schematic configuration of an information processing device.

FIG. 6 is a flowchart of molding processing executed in the three-dimensional molding system.

FIG. 7 is a diagram illustrating an example in which a three-dimensional shape of a three-dimensional molded object is displayed on a display unit.

FIG. 8 is a diagram illustrating an example in which the three-dimensional shape of the three-dimensional molded object is displayed on the display unit.

FIG. 9 is a diagram illustrating an example in which a portion in a molding target region is displayed on the display unit.

FIG. 10 is a diagram illustrating a generation method of first molding data.

FIG. 11 is a diagram illustrating another generation method of molding data in the first embodiment.

FIG. 12 is a diagram illustrating a generation method of molding data in a second embodiment.

FIG. 13 is a diagram illustrating a generation method of a travel path in the second embodiment.

FIG. 14 is a diagram illustrating a first region in a third embodiment.

FIG. 15 is a diagram illustrating a range in which a support structure is molded.

FIG. 16 is a diagram illustrating an example in which a plurality of first regions are designated.

FIG. 17 is a diagram illustrating a determination method of a molding target region in a fourth embodiment.

FIG. 18 is a diagram illustrating a generation method of molding data according to a fifth embodiment.

### DESCRIPTION OF EMBODIMENTS

### A. First Embodiment:

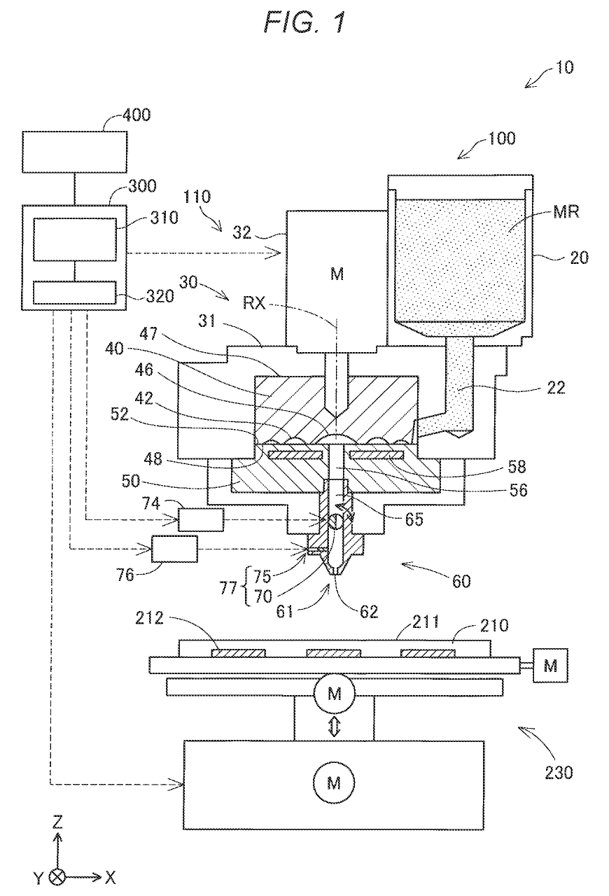

FIG. 1 is a diagram illustrating a schematic configuration of a three-dimensional molding system 10 in a first embodiment. FIG. 1 illustrates arrows indicating X, Y, and Z directions orthogonal to one another. The X direction and the Y direction are directions parallel to a horizontal plane. The Z direction is a direction along a vertically upward direction. The arrows indicating the X, Y, and Z directions are illustrated as appropriate in other drawings as well such that illustrated directions correspond to those in FIG. 1. In the following description, when a direction is specified, a direction indicated by an arrow in the drawings is represented as "+" and a direction opposite to the direction is represented as "-", and the positive and negative signs are also used in direction notation. In the following description, a +Z direction is also referred to as "upper", and a -Z direction is also referred to as "lower".

The three-dimensional molding system 10 includes a three-dimensional molding device 100 and an information processing device 400. The three-dimensional molding device 100 according to the embodiment is a device that forms a molded object by a material extrusion method. The three-dimensional molding device 100 includes a control unit 300 for each of controlling units of the three-dimensional molding device 100. The control unit 300 and the information processing device 400 are communicably connected.

The three-dimensional molding device 100 includes a molding unit 110 that generates and discharges a molding material, a stage 210 for molding serving as a base of the molded object, and a movement mechanism 230 that controls a discharge position of the molding material.

The molding unit 110 discharges the molding material obtained by plasticizing a material in a solid state onto the stage 210 under the control of the control unit 300. The molding unit 110 includes a material supply unit 20 that is a supply source of a raw material before being converted into the molding material, a plasticizing unit 30 that converts the raw material into the molding material, and a discharge unit 60 that discharges the molding material.

The material supply unit 20 supplies a raw material MR to the plasticizing unit 30. The material supply unit 20 is implemented by, for example, a hopper that accommodates the raw material MR. The material supply unit 20 is coupled to the plasticizing unit 30 via a communication path 22. The raw material MR is put into the material supply unit 20 in a form of powder or pellets. Examples of the raw material MR include thermoplastic resins such as an acrylonitrile-butadiene-styrene resin (ABS), a polypropylene resin (PP), a polyethylene resin (PE), and a polyacetal resin (POM).

The plasticizing unit 30 plasticizes the raw material MR supplied from the material supply unit 20 to generate a paste-molded molding material exhibiting fluidity and guides the molding material to the discharge unit 60. In the embodiment, the term "plasticize" is a concept including melting and means changing from a solid state to a state having fluidity. Specifically, in a case of a material in which glass transition occurs, the term "plasticize" refers to setting a temperature of the material to a temperature equal to or higher than a glass transition point. In a case of a material in which the glass transition does not occur, the term "plasticize" refers to setting a temperature of the material to a temperature equal to or higher than a melting point.

The plasticizing unit 30 includes a screw case 31, a drive motor 32, a flat screw 40, and a barrel 50. The flat screw 40 is also referred to as a rotor or a scroll. The barrel 50 is also referred to as a screw facing portion.

The flat screw 40 is housed in the screw case 31. An upper surface 47 of the flat screw 40 is coupled to the drive motor 32, and the flat screw 40 rotates in the screw case 31 by a rotational drive force generated by the drive motor 32. The drive motor 32 is driven under the control of the control unit 300. The flat screw 40 may be driven by the drive motor 32 via a speed reducer.

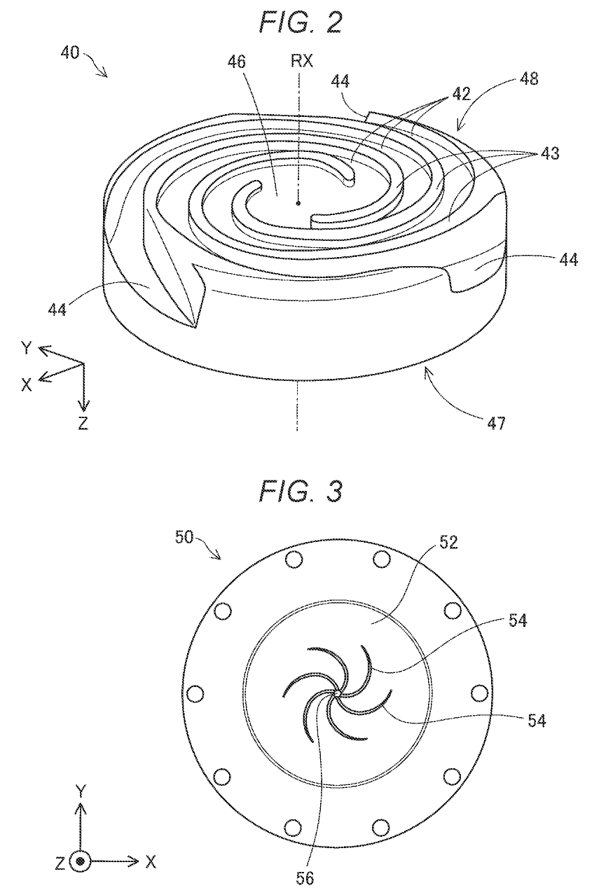

FIG. 2 is a perspective view illustrating a schematic configuration on a lower surface 48 side of the flat screw 40. To facilitate understanding of the technique, the flat screw 40 illustrated in FIG. 2 is illustrated in a state in which a positional relationship between the upper surface 47 and the lower surface 48 illustrated in FIG. 1 is reversed in a vertical direction. The flat screw 40 has a substantially cylindrical shape whose length in an axial direction that is a direction along a central axis thereof is smaller than a length in a direction perpendicular to the axial direction. The flat screw 40 is disposed such that a rotation axis RX that is a rotation center thereof is parallel to the Z direction.

Grooves 42 each having a vortex shape are formed in the lower surface 48, which is a surface crossing the rotation axis RX, of the flat screw 40. The communication path 22 of the material supply unit 20 described above communicates with the grooves 42 from a side surface of the flat screw 40. In the embodiment, three grooves 42 are formed being separated by ridge portions 43. The number of grooves 42 is not limited to three and may be one or two or more. The grooves 42 do not necessarily have a vortex shape and may have a spiral shape or an involute curve shape, or may have a shape extending arcuately from a central part toward an outer periphery.

As illustrated in FIG. 1, the lower surface 48 of the flat screw 40 faces an upper surface 52 of the barrel 50. A space is formed between the grooves 42 in the lower surface 48 of the flat screw 40 and the upper surface 52 of the barrel 50. The raw material MR is supplied from the material supply unit 20 to the space between the flat screw 40 and the barrel 50 through material inlets 44 illustrated in FIG. 2.

A barrel heater 58 for heating the raw material MR supplied into the grooves 42 of the rotating flat screw 40 is embedded in the barrel 50. A communication hole 56 is provided at a center of the barrel 50.

FIG. 3 is a schematic plan view illustrating an upper surface 52 side of the barrel 50. A plurality of guide grooves 54 coupled to the communication hole 56 and extending in a vortex shape from the communication hole 56 toward an outer periphery are formed in the upper surface 52 of the barrel 50. One end of the guide groove 54 may not be coupled to the communication hole 56. The guide grooves 54 may be omitted.

The raw material MR supplied into the grooves 42 of the flat screw 40 flows along the grooves 42 due to the rotation of the flat screw 40 while being plasticized in the grooves 42, and is guided to the central part 46 of the flat screw 40 as the molding material. The paste-molded molding material exhibiting fluidity, which flows into the central part 46, is supplied to the discharge unit 60 via the communication hole 56 provided at the center of the barrel 50. In the molding material, not all types of substances forming the molding material may be plasticized. The molding material may be converted into a state having fluidity as a whole by plasticizing at least a part of types of substances forming the molding material.

The discharge unit 60 illustrated in FIG. 1 includes a nozzle 61 that discharges the molding material, a flow path 65 of the molding material that is formed between the flat screw 40 and a nozzle opening 62, and a discharge control unit 77 that controls the discharge of the molding material.

The nozzle 61 is coupled to the communication hole 56 of the barrel 50 through the flow path 65. Through the nozzle 61, the molding material generated in the plasticizing unit 30 is discharged from the nozzle opening 62 at a tip end toward the stage 210.

The discharge control unit 77 includes a discharge adjustment unit 70 that opens and closes the flow path 65 and a suction unit 75 that suctions and temporarily stores the molding material.

The discharge adjustment unit 70 is provided in the flow path 65 and changes an opening degree of the flow path 65 by rotating in the flow path 65. In the embodiment, the discharge adjustment unit 70 is implemented by a valve. The discharge adjustment unit 70 is driven by a first drive unit 74 under the control of the control unit 300. The first drive unit 74 is implemented by, for example, a stepping motor. The control unit 300 can adjust a flow rate of the molding material flowing from the plasticizing unit 30 to the nozzle 61, that is, a discharge amount of the molding material discharged from the nozzle 61 by controlling a rotation angle of the discharge adjustment unit 70 using the first drive unit 74. The discharge adjustment unit 70 can adjust the discharge amount of the molding material and can control ON and OFF of an outflow of the molding material.

The suction unit 75 is coupled between the discharge adjustment unit 70 and the nozzle opening 62 in the flow path 65. The suction unit 75 temporarily suctions the molding material in the flow path 65 when the discharge of the molding material from the nozzle 61 is stopped, thereby preventing an elongating phenomenon in which the molding material hangs down like a string from the nozzle opening 62. In the embodiment, the suction unit 75 is implemented by a plunger. The suction unit 75 is driven by a second drive unit 76 under the control of the control unit 300. The second drive unit 76 is implemented, for example, by a stepping motor or a rack-and-pinion mechanism that converts a rotational force generated by the stepping motor into a translational motion of the plunger.

The stage 210 is disposed at a position facing the nozzle opening 62 of the nozzle 61. In the first embodiment, a molding surface 211 of the stage 210 facing the nozzle opening 62 of the nozzle 61 is parallel to the X and Y directions, that is, a horizontal direction. The stage 210 includes a stage heater 212 for preventing the molding material discharged onto the stage 210 from being suddenly cooled. The stage heater 212 is controlled by the control unit 300.

The movement mechanism 230 changes a relative position between the stage 210 and the nozzle 61 under the control of the control unit 300. In the embodiment, a position of the nozzle 61 is fixed, and the movement mechanism 230 moves the stage 210. The movement mechanism 230 is implemented by a three-axis positioner that moves the stage 210 in three axial directions including the X, Y, and Z directions by driving forces of three motors. In the present specification, unless noted otherwise, a movement of the nozzle 61 means moving the nozzle 61 or the discharge unit 60 with respect to the stage 210.

In another embodiment, a configuration in which the movement mechanism 230 moves the nozzle 61 with respect to the stage 210 in a state in which a position of the stage 210 is fixed may be adopted instead of a configuration in which the stage 210 is moved by the movement mechanism 230. In addition, a configuration in which the stage 210 is moved in the Z direction by the movement mechanism 230 and the nozzle 61 is moved in the X and Y directions, or a configuration in which the stage 210 is moved in the X and Y directions by the movement mechanism 230 and the nozzle 61 is moved in the Z direction may be adopted. With such configurations, a relative positional relationship between the nozzle 61 and the stage 210 can be changed.

Although only one molding unit 110 is illustrated in FIG. 1, the three-dimensional molding device 100 may include a plurality of molding units 110. By including the plurality of molding units 110, different types of molding materials can be discharged from each molding unit 110. Therefore, for example, a main body of the molded object and a support structure supporting the molded object can be molded by different types of molding materials.

The control unit 300 is a control device that controls operations of the entire three-dimensional molding device 100. The control unit 300 is implemented by a computer including one or more processors 310, a storage device 320 including a main storage device and an auxiliary storage device, and an input and output interface for receiving and outputting a signal from and to an outside. The processor 310 executes a program stored in the storage device 320, thereby controlling the molding unit 110 and the movement mechanism 230 according to molding data acquired from the information processing device 400 to form a molded object on the stage 210. The control unit 300 may be implemented by combining circuits instead of the computer.

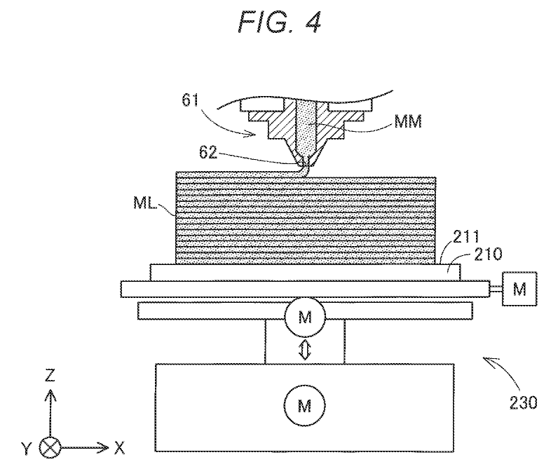

FIG. 4 is a diagram schematically illustrating a state in which the three-dimensional molding device 100 forms the molded object. As described above, the raw material MR in a solid state is plasticized to generate a molding material MM in the three-dimensional molding device 100. The control unit 300 causes the nozzle 61 to discharge the molding material MM while changing the position of the nozzle 61 with respect to the stage 210 in a direction along the molding surface 211 of the stage 210, maintaining the distance between the molding surface 211 of the stage 210 and the nozzle 61. The molding material MM discharged from the nozzle 61 is continuously deposited in a movement direction of the nozzle 61.

The control unit 300 forms layers ML by repeating the movement of the nozzle 61. After forming one layer ML, the control unit 300 moves the position of the nozzle 61 with respect to the stage 210 in the Z direction, which is a stacking direction of the layers ML. Then, the control unit 300 further stacks a layer ML on the layers ML that are formed so far to form the molded object.

For example, the control unit 300 may temporarily interrupt the discharge of the molding material from the nozzle 61 when the nozzle 61 moves in the Z direction in a case of completing one layer ML or when there are a plurality of independent molding regions in each layer. In this case, the flow path 65 is closed by the discharge adjustment unit 70, the discharge of the molding material MM from the nozzle opening 62 is stopped, and the molding material in the nozzle 61 is temporarily suctioned by the suction unit 75. After changing the position of the nozzle 61, the control unit 300 discharges the molding material in the suction unit 75 and opens the flow path 65 by the discharge adjustment unit 70, thereby restarting the deposition of the molding material MM from the changed position of the nozzle 61.

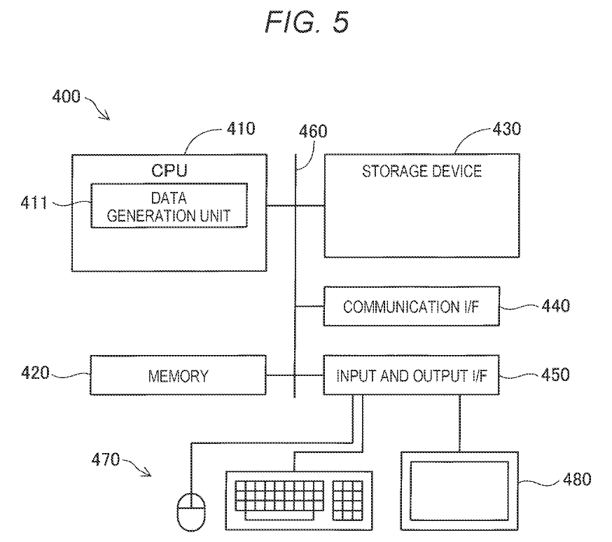

FIG. 5 is a diagram illustrating a schematic configuration of the information processing device 400. The information processing device 400 is implemented as a computer in which a CPU 410, a memory 420, a storage device 430, a communication interface 440, and an input and output interface 450 are coupled by a bus 460. An input device 470 such as a keyboard and a mouse and a display unit 480 such as a liquid crystal display are coupled to the input and output interface 450. The information processing device 400 is coupled to the control unit 300 of the three-dimensional molding device 100 via the communication interface 440.

The CPU 410 functions as a data generation unit 411 by executing a program stored in the storage device 430. The data generation unit 411 generates the molding data used by the three-dimensional molding device 100 to form the three-dimensional molded object.

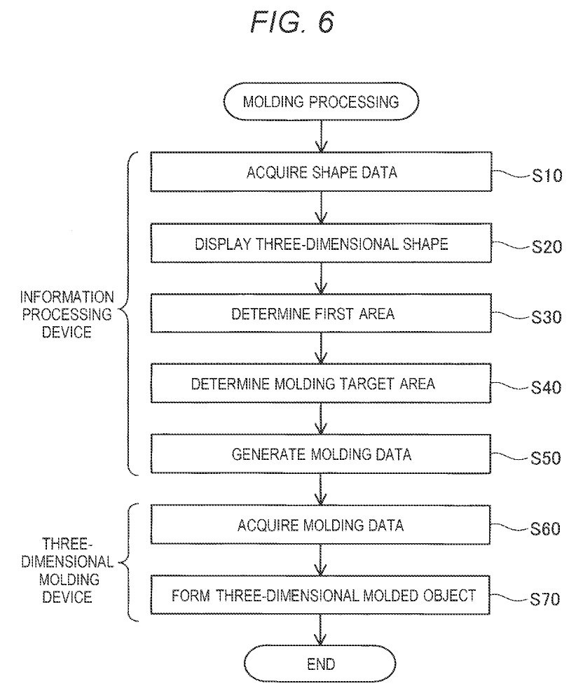

FIG. 6 is a flowchart of molding processing executed in the three-dimensional molding system 10. The molding processing is processing for implementing a method for manufacturing a three-dimensional molded object. Processing in steps S10 to S50 illustrated in FIG. 6 is executed in the information processing device 400, and processing in steps S60 and S70 is executed in the three-dimensional molding device 100.

In step S10, the data generation unit 411 of the information processing device 400 acquires shape data representing a three-dimensional shape of the three-dimensional molded object from another computer, a recording medium, or the storage device 430. The shape data is data representing a shape of the three-dimensional molded object created using three-dimensional CAD software, three-dimensional CG software, or the like. As the shape data, for example, data in an STL format or an AMF format is used.

In step S20, the data generation unit 411 displays the three-dimensional shape of the three-dimensional molded object on the display unit 480 based on the shape data acquired in step S10. Step S20 corresponds to a first step of the present disclosure.

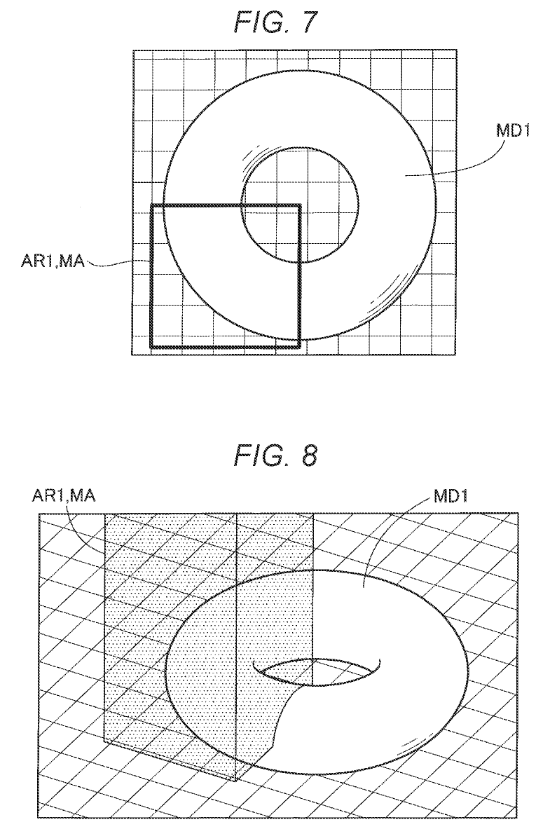

FIGS. 7 and 8 are diagrams illustrating examples in which the three-dimensional shape of the three-dimensional molded object is displayed on the display unit 480. FIGS. 7 and 8 illustrate examples in which a three-dimensional shape of a donut-molded three-dimensional molded object MD1 is displayed. FIG. 7 illustrates a display example of the three-dimensional molded object MD1 as viewed from above. FIG. 8 illustrates a display example of the three-dimensional molded object MD1 as viewed obliquely from above.

In step S30 in FIG. 6, the data generation unit 411 determines a first region AR1. The first region AR1 is a region defining a range of a surface perpendicular to the stacking direction, that is, a range of a surface along an X-Y plane. In the first embodiment, the data generation unit 411 determines the first region AR1 by receiving designation of a range of the first region AR1 from a user via the input device 470. In FIG. 7, a range indicated by a rectangle is the first region AR1. FIG. 8 illustrates a display example in which the range of the first region AR1 illustrated in FIG. 7 is stereoscopically viewed. As illustrated in FIG. 8, in the first embodiment, when the range of the first region AR1 is stereoscopically viewed, the range becomes columnar. The first region AR1 is designated by, for example, the user using a keyboard to input numerical values of coordinates indicating the range of the first region AR1 or operating a mouse to drag and select the range of the first region AR1.

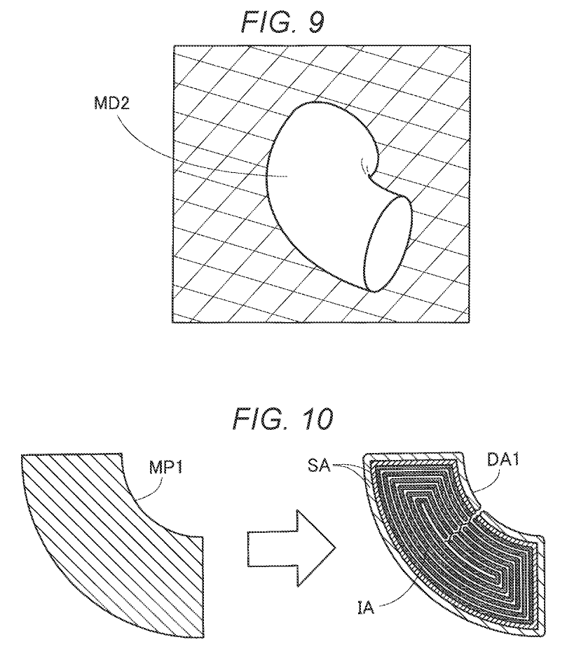

In step S40, the data generation unit 411 determines a molding target region MA. The molding target region MA is a region to be actually molded in the three-dimensional molded object MD1 indicated by the shape data by the three-dimensional molding device 100. In the first embodiment, the first region AR1 received in step S30 is directly determined as the molding target region MA. Steps S30 and S40 correspond to a second step of the present disclosure. FIG. 9 illustrates an example in which a portion MD2 in the molding target region MA of the three-dimensional molded object MD1 is displayed on the display unit 480.

In step S50, the data generation unit 411 generates the molding data. Step S50 corresponds to a third step of the present disclosure. In the first embodiment, the data generation unit 411 generates the molding data based on data of a portion corresponding to the molding target region MA in the shape data representing the shape of the three-dimensional molded object MD1. The molding data generated in the first embodiment is referred to as first molding data. Hereinafter, a portion corresponding to the molding target region in the three-dimensional molded object is referred to as a "molding target portion".

FIG. 10 is a diagram illustrating a generation method of the first molding data. A left side of the drawing illustrates a cross section of a molding target portion MP1, and a right side of the drawing illustrates visualized first molding data DA1 corresponding to the cross section. In generation of the first molding data DA1, the data generation unit 411 generates the first molding data DA1 by generating a molding path for each of an outer shell region SA representing an outer shell of the molding target portion MP1 and an infill region IA present inside the outer shell region SA. More specifically, the data generation unit 411 analyzes the shape data acquired in step S10 to slice the molding target portion MP1 into a plurality of layers along the X-Y plane. Then, the data generation unit 411 determines the molding path for molding the outer shell region SA for forming an outline in each layer and the infill region IA present in the outer shell region SA. The molding path is route information indicating a movement route of the nozzle 61. The route information includes data representing a plurality of linear movement routes. Each movement route included in the route information includes a discharge amount information indicating a discharge amount of the molding material discharged in the movement route. The data generation unit 411 generates the molding path by generating the route information and the discharge amount information for all the layers in the molding target region MA. A line width of the molding path is determined based on a length of the movement route represented by the molding path and the discharge amount of the molding material discharged in the movement route. FIG. 10 illustrates a molding path for two laps along an outline of the molding target portion MP1 as a molding path for molding the outer shell region SA. In addition, a molding path having a concentric circular infill pattern and an infill ratio of 100% is illustrated as a molding path for molding the infill region IA. The concentric circular infill pattern refers to a pattern in which an outline shape of the molded object is gradually reduced toward a center of the molded object. The number of laps of the molding path for molding the outer shell region SA, and the infill pattern and the infill ratio for molding the infill region IA may be freely set by the user.

The first molding data DA1 may include support data. When the molding target portion MP1 includes an overhang portion, the data generation unit 411 generates the support data for supporting the molding target portion from below. The overhang portion refers to a protruding portion of the three-dimensional molded object that is not supported from below. In the embodiment, the meaning of the overhang portion also includes a bridge portion. The bridge portion refers to a bridge-molded portion whose both ends are supported in the three-dimensional molded object. The data generation unit 411 generates the support data by specifying a spatial region below the overhang portion and generating the molding path according to a predetermined condition for the spatial region.

In step S60 in FIG. 6, the control unit 300 of the three-dimensional molding device 100 acquires the first molding data DA1 generated in step S50 from the information processing device 400.

In step S70, the control unit 300 controls the discharge unit 60 and the movement mechanism 230 according to the first molding data DA1 acquired from the information processing device 400 to form the three-dimensional molded object on the molding surface 211 of the stage 210. Since the first molding data DA1 is the molding data for molding the molding target portion MP1, in step S70, a portion corresponding to the molding target region MA in the three-dimensional molded object MD1 is molded as the three-dimensional molded object. Step S70 corresponds to a fourth step of the present disclosure.

In the first embodiment described above, the molding target region MA is determined based on the first region AR1 designated by the user, and the first molding data DA1 is generated based on the data of the portion corresponding to the molding target region MA in the shape data representing the three-dimensional shape of the three-dimensional molded object MD1. Then, based on the first molding data DA1, the portion corresponding to the molding target region MA in the three-dimensional molded object MD1 is molded as the three-dimensional molded object. Therefore, when test molding is performed to confirm an actual molding state of a part of the three-dimensional molded object, such as an overhang portion or a support structure, a portion other than a portion requiring confirmation is prevented from being molded. Therefore, it is possible to reduce a molding time during the test molding and reduce an amount of the used molding material. Such an effect is particularly noticeable when the test molding of a three-dimensional molded object having a large size is performed.

In the first embodiment, the first molding data DA1 is generated by generating the molding path for each of the outer shell region SA representing an outer shell of a portion corresponding to the molding target region MA in the shape data representing the three-dimensional molded object MD1 and the infill region IA present in the outer shell region SA. Therefore, the infill region IA is surrounded by the outer shell region SA, and the molding target portion MP1 in the three-dimensional molded object MD1 can be accurately molded.

In the first embodiment, the designation of the range of the first region AR1 is received, and the molding target region MA is determined based on the designation. Therefore, the user can designate the first region AR1 to be any range.

In the first embodiment, since a part of the three-dimensional molded object can be molded without correcting the shape data representing the shape of the three-dimensional molded object, the shape data may not be edited using three-dimensional CAD software or three-dimensional CG software. Therefore, even in an environment where there is no such software, a part of the three-dimensional molded object can be easily subjected to the test molding.

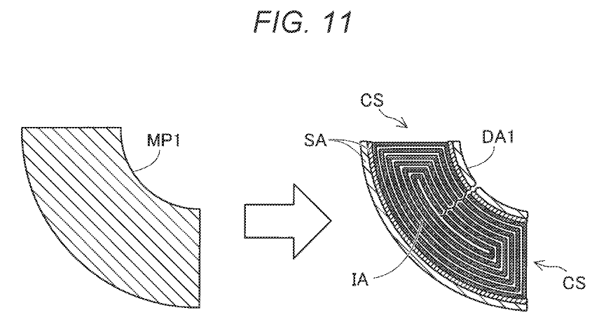

FIG. 11 is a diagram illustrating another generation method of the molding data in the first embodiment. In step S50 of the molding processing illustrated in FIG. 6, as illustrated in FIG. 11, the data generation unit 411 may not generate a molding path for surrounding a cut surface CS along which the three-dimensional shape of the three-dimensional molded object MD1 is cut by the molding target region MA. That is, the outer shell region SA may be generated for an outline portion originally present in the three-dimensional molded object MD1, and the outer shell region SA may not be generated for a surface generated by cutting due to the molding target region MA. In this case, the molding path is generated with the same method as the method illustrated in FIG. 10 for the infill region IA. When the first molding data DA1 is generated in this manner, the outer shell region SA of the molding target portion MP1 can be molded by the same molding path as when molding the entire three-dimensional molded object MD1.

### B. Second Embodiment:

A configuration of the three-dimensional molding system 10 according to a second embodiment is the same as that of the three-dimensional molding system 10 of the first embodiment. The second embodiment is different from the first embodiment in a generation method of molding data in step S50 of the molding processing illustrated in FIG. 6. Processing contents of steps S10 to S40 and steps S60 and S70 are the same as those of the first embodiment, and therefore only the processing content of step S50 will be described below.

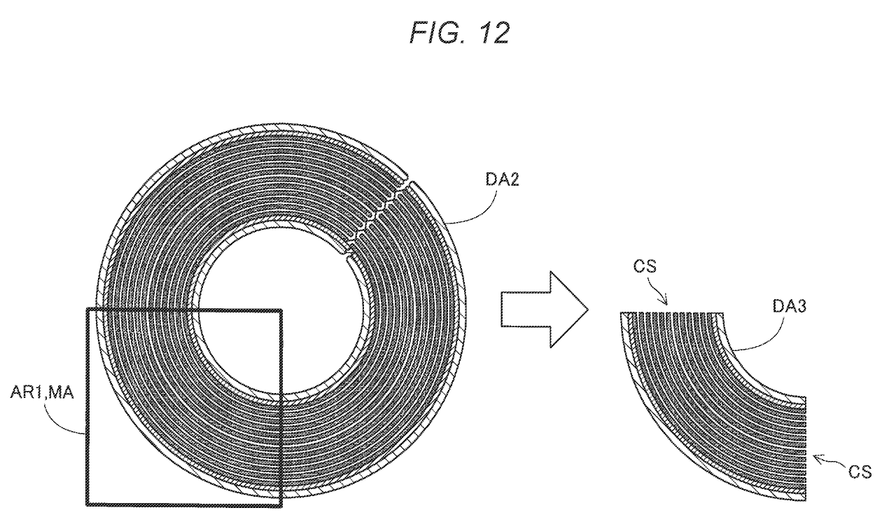

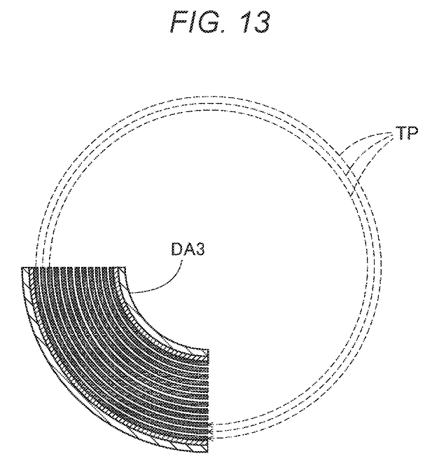

FIG. 12 is a diagram illustrating a generation method of the molding data in the second embodiment. In the second embodiment, the data generation unit 411 generates third molding data DA3 by selecting data of a portion corresponding to the molding target region MA from second molding data DA2 generated based on shape data of the three-dimensional molded object MD1. The molding data generated in the second embodiment is referred to as the third molding data DA3. Specifically, first, the data generation unit 411 analyzes the shape data representing a shape of the three-dimensional molded object MD1 and generates the second molding data DA2 for molding the entire three-dimensional molded object as illustrated on a left side of FIG. 12. Next, as illustrated on the right side of FIG. 12, the data generation unit 411 generates the third molding data DA3 by selecting and extracting the data of the portion corresponding to the molding target region MA from the second molding data DA2. In the step of generating the third molding data DA3 from the second molding data DA2, a molding path for surrounding the cut surface CS along which the three-dimensional shape represented by the second molding data DA2 is cut by the molding target region MA is not generated. That is, when the third molding data DA3 is generated from the second molding data DA2, a new molding path is not generated. In step S70 illustrated in FIG. 6, based on the third molding data DA3 generated in this manner, a portion corresponding to the molding target region MA in the three-dimensional molded object MD1 is molded as the three-dimensional molded object.

FIG. 13 is a diagram illustrating a generation method of a travel path TP in the second embodiment. In the step of generating the third molding data DA3, the data generation unit 411 converts a molding path included in data other than a portion corresponding to the molding target region MA in the second molding data DA2 into a travel path TP. The travel path TP is a path for moving the nozzle 61 from a discharge end position to a next discharge start position in a state of not discharging the molding material. The data generation unit 411 converts the molding path into the travel path TP by setting discharge amount information of the molding path for molding a portion other than the portion corresponding to the molding target region MA to zero. The data generation unit 411 may generate a travel path connecting the molding paths with the shortest distance.

In the second embodiment described above, the third molding data DA3 for molding the molding target portion is generated by selecting the data of the portion corresponding to the molding target region MA from the second molding data DA2 for molding the entire three-dimensional molded object MD1. Therefore, the molding target portion can be molded by the same molding path as when molding the entire three-dimensional molded object MD1. As a result, molding accuracy of the molding target portion can be made close to molding accuracy when molding the entire three-dimensional molded object MD1. Also in the second embodiment, similarly to the first embodiment, when test molding is performed to confirm an actual molding state of a part of the three-dimensional molded object, a portion other than a portion requiring confirmation is prevented from being molded. Therefore, an amount of the used molding material can be reduced during the test molding.

In the second embodiment, the third molding data DA3 for molding the molding target portion can be generated by converting the molding path included in the data other than the portion corresponding to the molding target region MA in the second molding data DA2 into the travel path TP. Therefore, the third molding data DA3 can be generated from the second molding data DA2 with simple processing. If the molding path is converted into the travel path TP, a time required for molding the molding target portion can be made close to a time required for molding the entire three-dimensional molded object MD1. Therefore, the molding accuracy of the molding target portion can be made close to molding accuracy when molding the entire three-dimensional molded object.

As described above, in the second embodiment, the time required for molding the molding target portion is made close to the time required for molding the entire three-dimensional molded object MD1 by converting the molding path included in the data other than the portion corresponding to the molding target region MA in the second molding data DA2 into the travel path TP. In contrast, instead of converting the molding path into the travel path TP, the time required for molding the molding target portion may be made close to the time required for molding the entire three-dimensional molded object MD1 by setting the molding path such that the nozzle 61 is caused to stand by at a position outside the molding target region MA for a predetermined time each time the molding of each layer is completed or a columnar object called a prime pillar is molded at a position outside the molding target region MA. By adjusting the molding time of each layer of the molding target portion in this manner, the temperature state of each layer at the time of molding can be brought close to the temperature state in the case of molding the entire three-dimensional molded object MD1. Therefore, the molding accuracy of the molding target portion can be made close to the molding accuracy when the entire three-dimensional molded object is molded.

In the second embodiment, as illustrated in FIG. 13, the molding path included in the data other than the portion corresponding to the molding target region MA in the second molding data DA2 is converted into the travel path. In contrast, the data generation unit 411 may set a new travel path between adjacent molding paths in the cut surface CS along which the three-dimensional shape represented by the second molding data DA2 is cut by the molding target region MA. In this manner, the molding time of the molding target portion can be reduced.

### C. Third Embodiment:

A configuration of the three-dimensional molding system 10 according to a third embodiment is the same as that of the three-dimensional molding system 10 of the first embodiment. In the first embodiment, the data generation unit 411 receives designation of the first region AR1 from the user in step S30 of the molding processing illustrated in FIG. 6. In contrast, in the third embodiment, in step S30 in FIG. 6, the data generation unit 411 analyzes shape data representing a shape of a three-dimensional molded object to determine the first region AR1. Processing contents of steps S10 and S20 and steps S40 to S70 are the same as those of the first embodiment, and therefore only the processing content of step S30 will be described below.

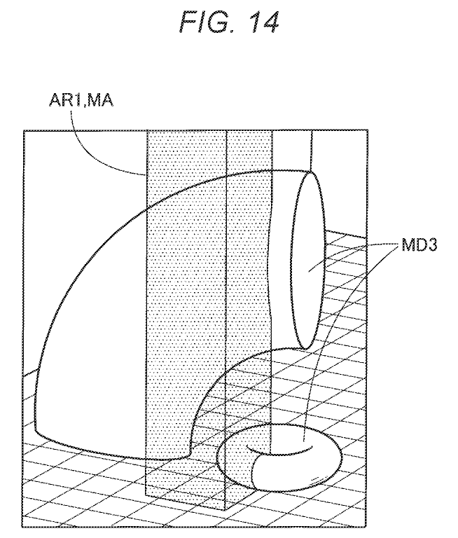

FIG. 14 is a diagram illustrating the first region AR1 determined by the data generation unit 411. In the third embodiment, the data generation unit 411 detects a region in which a plurality of objects overlap in a stacking direction by analyzing the shape data and determines the detected region as the first region AR1. A range of a region automatically detected by the data generation unit 411 may be adjustable within the display unit 480 by the user. FIG. 14 illustrates an example in which a three-dimensional molded object MD3 including a plurality of objects is displayed on the display unit 480, and a region in which the plurality of objects overlap in the stacking direction is determined as the first region AR1. FIG. 15 illustrates a range in which a support structure SS is molded when the three-dimensional molded object MD3 illustrated in FIG. 14 is molded. The data generation unit 411 determines the molding target region MA based on the first region AR1 illustrated in FIG. 14 and shapes a portion corresponding to the molding target region MA in the three-dimensional molded object MD3 to confirm peel ability of the support structure SS in a space sandwiched between the plurality of objects.

The data generation unit 411 may analyze the shape data representing the shape of the three-dimensional molded object and determine, as the first region AR1, a region in which the support structure SS is molded, a region in which an overhang portion is molded, a region in which a width for molding is less than a predetermined width, or a region in which a hole having a diameter less than a predetermined diameter is formed in addition to the region in which the plurality of objects overlap in the stacking direction. The user may be able to designate through the input device 470 which of these conditions the region corresponds to is determined as the first region AR1.

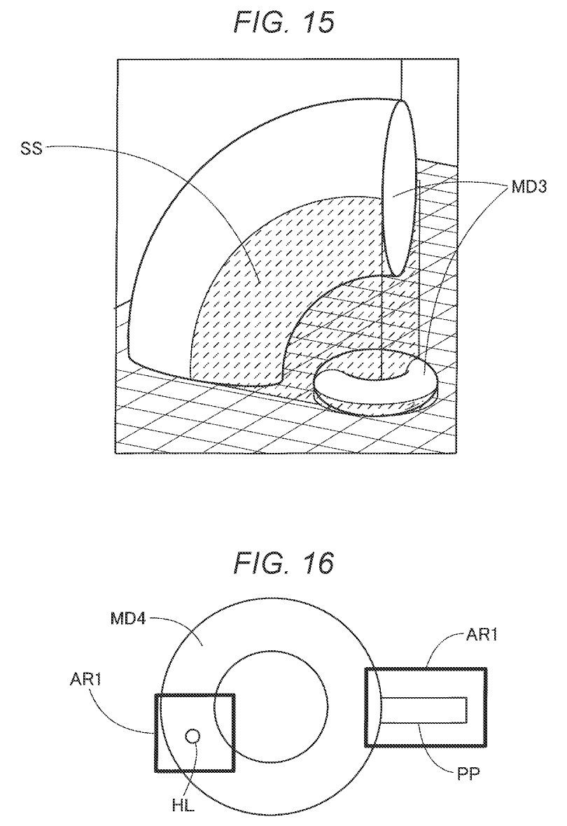

FIG. 16 is a diagram illustrating an example in which a plurality of the first regions AR1 are designated. FIG. 16 illustrates a state in which a donut-molded three-dimensional molded object MD4 is viewed from above. The first region AR1 is not limited to one location, and may be designated in a plurality of locations for one three-dimensional molded object MD4 as illustrated in FIG. 16. All of the plurality of first regions AR1 may be automatically specified by the data generation unit 411, or a part or all of the first regions AR1 may be designated by the user. FIG. 16 illustrates an example in which a first region is automatically specified in each of a portion in which a hole HL is formed and a portion in which a rod-molded protrusion PP is formed in the donut-molded three-dimensional molded object MD4.

### D. Fourth Embodiment:

A configuration of the three-dimensional molding system 10 according to a fourth embodiment is the same as that of the three-dimensional molding system 10 of the first embodiment. The fourth embodiment is different from the first embodiment in a determination method of a molding target region in step S40 of the molding processing illustrated in FIG. 6. Processing contents of steps S10 to S30 and steps S50 to S70 are the same as those of the first embodiment, and therefore only the processing content of step S40 will be described below.

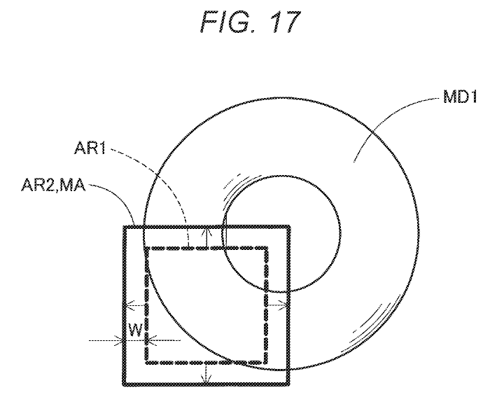

FIG. 17 is a diagram illustrating a determination method of a molding target region in the fourth embodiment. In the first embodiment, the first region AR1 received in step S30 is directly determined as the molding target region MA. In contrast, in the fourth embodiment, as illustrated in FIG. 17, the data generation unit 411 determines a second region AR2 that includes the first region AR1 and is a range larger than the first region AR1 in the X-Y plane as the molding target region MA.

In this manner, by determining the second region AR2 larger than the first region AR1 as the molding target region MA, molding accuracy in the first region AR1 can be maintained even when molding accuracy in a peripheral portion of the molding target portion decreases. As a result, the molding accuracy in the first region AR1 of the three-dimensional molded object MD1 can be made close to molding accuracy when molding the entire three-dimensional molded object MD1.

In the fourth embodiment, a width W of a region obtained by excluding the first region AR1 from the second region AR2 may be larger than a line width of a molding path and may be equal to or less than three times the line width of the molding path. When such a width W is ensured, for example, an end point and a start point of the molding path can be accommodated in the width W rather than in the first region AR1, or a new outer shell is formed, the newly formed outer shell can be accommodated within the width W. As a result, since the molding target region MA is determined based on the second region AR2 that is larger than the first region AR1, an amount of the used molding material increases. The molding path in the first region AR1 can be set to the same path as when molding the entire three-dimensional molded object while reducing an increase in the usage amount to a minimum limit. Therefore, the molding accuracy in the first region AR1 of the three-dimensional molded object MD1 can be easily made close to the molding accuracy when molding the entire three-dimensional molded object MD1molded.

### E. Fifth Embodiment:

A configuration of the three-dimensional molding system 10 according to a fifth embodiment is the same as that of the three-dimensional molding system 10 of the first embodiment. In the fifth embodiment, processing contents of steps S30 to S50 of molding processing illustrated in FIG. 6 are different from those of the first embodiment. Processing contents of steps S10 and S20 and steps S60 and S70 are the same as those of the first embodiment, and therefore only the processing contents of steps S30 to S50 will be described below.

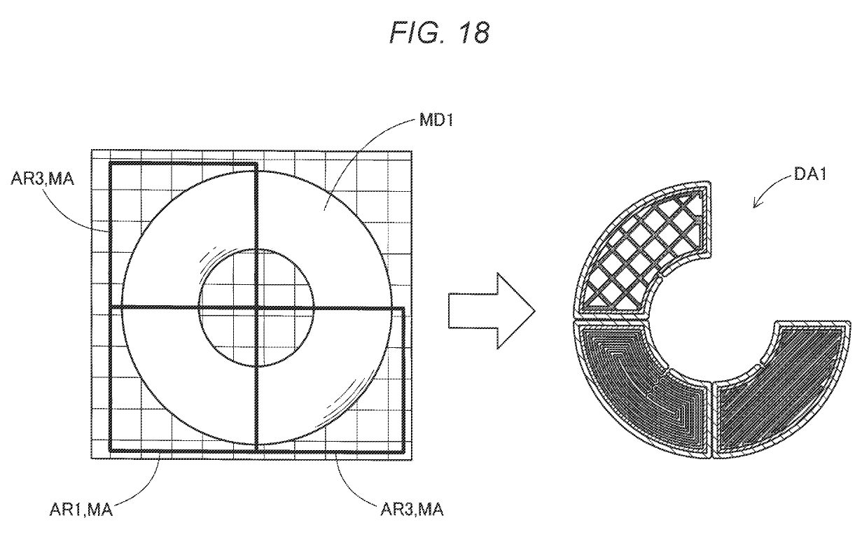

FIG. 18 is a diagram illustrating a generation method of molding data in the fifth embodiment. In the fifth embodiment, in step S30 in FIG. 6, designation of a range of not only the first region AR1 but also a third region AR3 is received from a user. Similarly to the first region AR1, the third region AR3 is a region that defines a range of a surface perpendicular to a stacking direction and is different from the first region AR1. FIG. 18 illustrates an example in which the first region AR1 and two of the third regions AR3 are designated.

In the fifth embodiment, in step S40 in FIG. 6, the data generation unit 411 determines the molding target region MA based on the first region AR1 and the third regions AR3. Specifically, the data generation unit 411 sets a region including the first region AR1 and the third regions AR3 as the molding target region MA. In FIG. 6, the first region AR1 and the two third regions AR3 are in contact, and these regions may be separated from one another. When the first region AR1 and the third regions AR3 are separated from one another, a region located between the first region AR1 and the third regions AR3 may be included in the molding target region MA.

In the fifth embodiment, in step S50 in FIG. 6, the data generation unit 411 generates the first molding data DA1 by applying different molding conditions to data of a portion corresponding to the first region AR1 in shape data of the three-dimensional molded object MD1 and data of a portion corresponding to the third region AR3 in the shape data. FIG. 18 illustrates an example in which the first molding data DA1 is generated such that the first region AR1 and the third regions AR3 have different infill patterns and infill ratios. Molding conditions of the third region AR3 may be freely designated by the user. When a plurality of the third regions AR3 are designated, different molding conditions may be designated for the third regions AR3. In the first region AR1 and the third regions AR3, various molding conditions can be made different, such as a type of the support structure SS, a type of the molding material, the number of laps of the outer shell, and the like, without being limited to the infill pattern and the infill ratio.

According to the fifth embodiment described above, a plurality of portions of the three-dimensional molded object MD1 can be molded under different molding conditions. Therefore, when test molding is performed to confirm an actual molding state of a part of the three-dimensional molded object MD1, a molding state of a portion molded under the molding conditions different from the actual molding conditions can be confirmed.

### F. Other Embodiments:

(F1) In the above-described embodiments, a range of the first region may be designated not only in the X direction and the Y direction but also in the Z direction. In this case, the user may designate the range in the Z direction after designating the range in the X and Y directions, or may designate the range in the X and Y directions after designating the range in the Z direction.

(F2) In the above-described embodiments, the shape of the first region is not limited to a rectangle. For example, a circle may be used, or a polygon other than a rectangle such as a triangle or a pentagon may be used. Alternatively, any shape drawn freehand by the user may be used. The first region is not limited to be columnar, and may be any three-dimensional region such as a cone shape, a spherical shape, or a polygonal shape.

(F3) In the above-described embodiments, the molding unit 110 plasticizes the material with the flat screw 40. In contrast, the molding unit 110 may plasticize the material by, for example, rotating an in-line screw. The molding unit 110 may plasticize a filament material with a heater.

(F4) In the above-described embodiments, a material extrusion method in which the plasticized material is stacked is described as an example, and the present disclosure can be applied to various methods such as an inkjet method, a direct metal deposition (DMD) method, and a binder jet method.

### G. Other aspects:

The present disclosure is not limited to the embodiments described above and may be achieved with various configurations without departing from the intent of the present disclosure. For example, technical features in the embodiments corresponding to technical features in aspects explained below can be replaced or combined as appropriate in order to solve a part or all of the problems described above or in order to achieve a part or all of the effects described above. The technical features can be deleted as appropriate unless described as essential technical features in the present specification.

(1) According to a first aspect of the present disclosure, there is provided a method for manufacturing a three-dimensional molded object by discharging a molding material from a discharge unit toward a stage to stack layers. The manufacturing method includes: a first step of displaying a three-dimensional molded object on a display unit based on shape data representing a three-dimensional shape of the three-dimensional molded object; a second step of determining a molding target region in the three-dimensional molded object displayed on the display unit based on a first region defining a range of a surface perpendicular to a stacking direction of the layer; a third step of generating first molding data based on data of a portion corresponding to the molding target region in the shape data, or generating third molding data by selecting the data of the portion corresponding to the molding target region from second molding data generated based on the shape data; and a fourth step of forming the three-dimensional molded object based on the first molding data or the third molding data.

According to such an aspect, the molded object corresponding to the molding target region of the three-dimensional molded object is molded. Therefore, when test molding is performed to confirm an actual molding state of a part of the three-dimensional molded object, a portion other than a portion requiring confirmation is prevented from being molded.

(2) In the above-described aspect, the third step may include a step of generating the first molding data by generating a molding path for each of an outer shell region representing an outer shell of the portion corresponding to the molding target region in the shape data and an infill region present inside the outer shell region. According to such an aspect, since the infill region is surrounded by the outer shell region, the molding target portion in the three-dimensional molded object can be accurately molded.

(3) In the above-described aspect, in the step of generating the first molding data, a molding path for surrounding a cut surface along which the three-dimensional shape is cut by the molding target region may not be generated. According to such an aspect, the outer shell region of the molding target portion can be molded by the same molding path as when molding the entire three-dimensional molded objectmolded.

(4) In the above-described aspect, in the step of generating the third molding data, a molding path included in data other than a portion corresponding to the molding target region in the second molding data may be converted into a travel path. According to such an aspect, the third molding data can be generated from the second molding data with simple processing.

(5) In the above-described aspect, in the second step, a second region that includes the first region and is a range larger than the first region may be determined as the molding target region. According to such an aspect, it is possible to maintain the molding accuracy in the first region even when the molding accuracy in the peripheral portion of the molding target portion decreases.

(6) In the above-described aspect, when viewed from the stacking direction, a width of a region obtained by excluding the first region from the second region may be larger than a line width of a molding path and may be equal to or less than three times the line width. According to such an aspect, the molding accuracy in the first region of the three-dimensional molded object can be easily made close to the molding accuracy when molding the entire three-dimensional molded object while preventing the amount of the used molding material from increasing.

(7)In the above-described aspect, in the second step, the molding target region may be determined based on the first region and a third region that is a region defining a range of a surface perpendicular to the stacking direction and is different from the first region, and in the third step, the first molding data may be generated by applying different molding conditions to data of a portion corresponding to the first region in the shape data and data of a portion corresponding to the third region in the shape data. According to such an aspect, a plurality of portions of the three-dimensional molded object can be molded under different molding conditions.

(8) In the above-described aspect, the second step may include a step of receiving designation of a range of the first region in the display unit. According to such an aspect, the user can designate the first region in any range.

The present disclosure is not limited to the method for manufacturing a three-dimensional molded object described above, and can be implemented in various aspects such as a three-dimensional molding system, an information processing device, a computer program, or a non-transitory tangible recording medium in which a computer program is recorded in a computer-readable manner.

What is claimed is:

1. A method for manufacturing a three-dimensional molded object by discharging a molding material from a discharge unit toward a stage to stack layers, the method comprising:
a first step of displaying a three-dimensional molded object on a display unit based on shape data representing a three-dimensional shape of the three-dimensional molded object;
a second step of determining a molding target region in the three-dimensional molded object displayed on the display unit based on a first region defining a range of a surface perpendicular to a stacking direction of the layer;
a third step of generating first molding data based on data of a portion corresponding to the molding target region in the shape data, or generating third molding data by selecting the data of the portion corresponding to the molding target region from second molding data generated based on the shape data; and
a fourth step of forming the three-dimensional molded object based on the first molding data or the third molding data.

2. The method for manufacturing a three-dimensional molded object according to claim 1, wherein
the third step includes a step of generating the first molding data by generating a molding path for each of an outer shell region representing an outer shell of the portion corresponding to the molding target region in the shape data and an infill region present inside the outer shell region.

3. The method for manufacturing a three-dimensional molded object according to claim 2, wherein
in the step of generating the first molding data, a molding path for surrounding a cut surface along which the three-dimensional shape is cut by the molding target region is not generated.

4. The method for manufacturing a three-dimensional molded object according to claim 1, wherein
in the step of generating the third molding data, a molding path included in data other than a portion corresponding to the molding target region in the second molding data is converted into a travel path.

5. The method for manufacturing a three-dimensional molded object according to claim 1, wherein
in the second step, a second region that includes the first region and is a range larger than the first region is determined as the molding target region.

6. The method for manufacturing a three-dimensional molded object according to claim 5, wherein
when viewed from the stacking direction, a width of a region obtained by excluding the first region from the second region is larger than a line width of a molding path and is equal to or less than three times the line width.

7. The method for manufacturing a three-dimensional molded object according to claim 1, wherein
in the second step, the molding target region is determined based on the first region and a third region that is a region defining a range of a surface perpendicular to the stacking direction and is different from the first region, and
in the third step, the first molding data is generated by applying different molding conditions to data of a portion corresponding to the first region in the shape data and data of a portion corresponding to the third region in the shape data.

8. The method for manufacturing a three-dimensional molded object according to claim 1, wherein
the second step includes a step of receiving designation of a range of the first region in the display unit.
